(19) United States
(12) Patent Application Publication
(10) Pub. No.: US 2010/0231823 A1
(43) Pub. Date: Sep. 16, 2010

(54) OPTICAL SHEET, SURFACE LIGHT SOURCE DEVICE, AND DISPLAY DEVICE

(75) Inventors: Masahiro Goto, Mihara-Shi (JP); Daijiro Kodama, Mihara-Shi (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 12/644,495

(22) Filed: Dec. 22, 2009

(30) Foreign Application Priority Data
Dec. 26, 2008 (JP) 2008-334674
Feb. 2, 2009 (JP) 2009-021602

(51) Int. Cl. G02F 1/1335; F21V 11/00; F21V 3/04

(52) U.S. Cl. 349/62; 362/317; 362/355; 362/311.01

(57) ABSTRACT

An optical sheet (40) includes a body portion (42) and unit shaped elements (45) arranged side-by-side on a light outgoing side of the body portion, each of the unit shaped elements extending linearly in a direction intersecting the arrangement direction. Each of the unit shaped elements has a tapered cross-sectional shape in a main cross-section. In a main cross-section, the angle of the tangent to either end of the outline of each unit shaped element with respect to the sheet plane of the body portion is not less than 55° and not more than 75°. The optical sheet makes it possible to enhance the efficiency in the use of source light, thereby effectively enhancing the front direction luminance.

### CROSS-REFERENCE TO RELATED APPLICATIONS

This application is based on and claims the benefit of priority from Japanese Patent Application No. 2008-334674, filed on Dec. 26, 2008, and Japanese Patent Application No. 2009-21602, filed on Feb. 2, 2009, the entire contents of which are incorporated herein by reference.

### BACKGROUND OF THE INVENTION

1. Field of the Invention

The present invention relates to an optical sheet, a surface light source device and a display device which can enhance the efficiency in the use of source light, thereby effectively enhancing the front direction luminance.

2. Description of the Related Art

A surface light source device for use in a transmissive display device includes a light source and a number of optical sheets (optical films) for changing the direction of light from the light source. The optical sheets include a light diffusing sheet for diffusing light from the light source so as to hide (obscure) the image of the light source, and a light colleting sheet (light condensing sheet) for collecting (condensing) light in the front direction so as to enhance the front direction luminance. A transmissive display device, having a desired front direction luminance and a desired viewing angle and in which the image of a light source is made obscure, can be obtained when a surface light source device is constructed by using an appropriate combination of a light diffusing sheet having light diffusing properties at an adjusted level, and a light colleting sheet having light collecting properties (light condensing properties) at an adjusted level.

An optical sheet, having linear unit shaped elements (unit optical elements) arranged in a direction perpendicular to the longitudinal direction of the elements (so-called linear array), is widely used as a light colleting sheet (see e.g. JP 10-506500T). In particular, unit prisms each having the shape of a triangle, typically an isosceles triangle having an apex angle of 90°, in a cross-section perpendicular to the longitudinal direction (main cross-section), are most commonly used as unit shaped elements.

For a display device, the luminance in the front direction is one of the most important evaluation items. The light colleting sheet disclosed in JP 10-506500T can perform a light collecting function due to the cross-sectional shape of the unit shaped element. There is, however, a demand for further enhancement of the front direction luminance. Enhancement of the front direction luminance has been studied not only in the designing of a light colleting sheet but also in terms of a combination of a light colleting sheet with other members, such as a light diffusing sheet and a light source.

Conforming to the social trend toward attaching increasing importance to environmental protection, enhancement of the efficiency in the use of source light has also been taken up as an important problem recently. It is highly desirable if the front direction luminance of a display device can be enhanced with enhancement of the efficiency in the use of source light.

### SUMMARY OF THE INVENTION

The present invention has been made in view of the above situation. It is therefore an object of the present invention to provide an optical sheet which can effectively enhance the front direction luminance by enhancing the efficiency in the use of source light. It is also an object of the present invention to provide a surface light source device and a display device which can effectively enhance the front direction luminance by enhancing the efficiency in the use of source light.

When the front direction luminance is enhanced, there is a possibility that the luminance enhancement bring about a rapid change in the angular distribution of luminance (so-called cut-off). It will be favorable if the optical sheet, the light source device and the display device according to the present invention can prevent the occurrence of such an undesirable phenomenon.

It has been found through the present inventors' experiments that a sufficient polarization separation function can be imparted to an optical sheet having unit shaped elements (unit lenses, unit prisms) arranged in a linear array, and that the efficient use of the polarization separation function can enhance the efficiency in the use of source light, thereby effectively enhancing the front direction luminance. In particular, it has been found that of light which enters the light outgoing surfaces of unit shaped elements at an incident angle which allows the light to exit in the front direction through refraction of the light at the light outgoing surfaces, the transmittance of a particular polarization component (e.g. P wave) can be enhanced and the transmittance of the other polarization component (e.g. S wave) can be lowered (reflectance can be enhanced), which, in combination with a transmissive display unit, makes it possible to enhance the efficiency in the use of source light, thereby effectively enhancing the front direction luminance. The present invention is based on such findings.

An optical sheet according to one aspect of the present invention comprises:

a sheet-like body portion; and

unit shaped elements arranged in a arrangement direction on a light outgoing side of the body portion, each of the unit shaped elements extending linearly in a direction intersecting the arrangement direction of the unit shaped elements,

wherein each of the unit shaped element has a tapered cross-sectional shape in a main cross-section which is parallel to both the normal direction of the body portion and the arrangement direction of the unit shaped elements, and

wherein in the main cross-section, an angle of a tangent to either end of an outline of each of the unit shaped elements with respect to a sheet plane of the body portion is not less than 55° and not more than 75°.

In the optical sheet according to one aspect of the present invention, in the main cross-section, an angle of a tangent to the outline of each of the unit shaped elements with respect to the sheet plane of the body portion may increase as a tangent point of the tangent on the unit shaped element moves from a top of the outline of the unit shaped element, the farthest point from the body potion, toward either end of the outline of the unit shaped element.

In the optical sheet according to one aspect of the present invention, in the main cross-section, the angle of the tangent to either end of the outline of each of the unit shaped elements with respect to the sheet plane of the body portion may be not less than 65° and not more than 75°.

In the optical sheet according to one aspect of the present invention, the body portion may have an anisotropic diffusion function that allows transmitted light to diffuse mainly in the arrangement direction of the unit shaped elements.

In the optical sheet according to one aspect of the present invention, a light incident side surface of the body portion may be comprised of a large number of unit lenses arranged in a arrangement direction, each of the unit lenses extending linearly in a direction intersecting the arrangement direction of the unit lenses.

In the optical sheet according to one aspect of the present invention, linearly-extending raised and recessed portions may be formed in a light incident side surface of the body portion. In this optical sheet, the raised and recessed portions may have been formed by hairline processing.

In the optical sheet according to one aspect of the present invention, in the main cross-section, a tangent in contact with the outline of each of the unit shaped elements at a position which is displaced from the end of the unit shaped element by a distance corresponding to 15% of a width of the unit shaped element in a direction parallel to the sheet plane of the body portion, may make an angle of not less than 40° with the sheet plane of the body portion.

In the optical sheet according to one aspect of the present invention, in the main cross-section, a tangent to the outline of each of the unit shaped elements may make an angle of not less than 0° and not more than 15° with the sheet plane of the body portion when a tangent point of the tangent on the outline of the unit shaped element lies in a region that accounts for at least 15% of the full width of each of the unit shaped element in a direction parallel to the sheet plane of the body portion.

In the optical sheet according to one aspect of the present invention, each of the unit shaped elements may be configured such that of light which travels toward the and of the unit shaped element in a direction parallel to the main cross-section and part of which is refracted at the light outgoing surface of the unit shaped element and outgoes in the normal direction of the body potion, the other part of the light, which is reflected from the light outgoing surface of the unit shaped element without refraction, either later outgoes from the unit shaped element at an light outgoing angle of not less than 80° or, after outgoing from the unit shaped element, enters an adjacent unit shaped element.

In the optical sheet according to one aspect of the present invention, in the main cross-section, the outline of each of the unit shaped elements may be composed of three or more joined arcs, with adjacent two joined arcs having a common tangent at their joint.

In the optical sheet according to one aspect of the present invention, the outline of each of the unit shaped elements in the main cross-section may be line-symmetrical with respect to a symmetry axis which is parallel to the normal direction of the body portion.

A surface light source device according to one aspect of the present invention comprises:

a light source; and

one of the above optical sheets according to one aspect of the present invention which receives light from the light source.

The surface light source device according to one aspect of the present invention may further comprise a light guide plate, wherein the light source may include a pair of light sources disposed oppositely on side surfaces of the light guide plate.

The surface light source device according to one aspect of the present invention may further comprise a light colleting sheet; wherein the light colleting sheet includes: a sheet-like body portion; and unit shaped elements arranged in a arrangement direction on a light outgoing side of the body portion, each of the unit shaped elements extending linearly in a direction intersecting the arrangement direction of the unit shaped elements of the light collecting sheet;

wherein the light source includes linear light emitters;

wherein the arrangement direction of the unit shaped elements of the light colleting sheet intersects the longitudinal in direction of the light emitters of the light source and also intersects the arrangement direction of the unit shaped elements of the optical sheet; and

wherein in a main cross-section of the light colleting sheet, which is parallel to both the normal direction of the body portion of the light colleting sheet and the arrangement direction of the unit shaped elements of the light colleting sheet, a width of each of the unit shaped elements of the light colleting sheet, along a direction parallel to the sheet plane or the body portion of the light collecting sheet, is not less than 1.8 times and not more than 2.3 times a height of the unit shaped element of the light colleting sheet along the normal direction of the body portion of the light colleting sheet.

A display device according to one aspect of the present invention comprises:

one of the above surface light source devices according to the present invention; and

a transmissive display unit disposed on the light outgoing side of the surface light source device.

In the display device according to one aspect of the present invention, the transmissive display unit may include a lower light polarizing plate and an upper light polarizing plate disposed on the light outgoing side of the lower light polarizing plate, and a transmission axis of the lower polarizing plate may intersect the longitudinal direction of the unit shaped elements of the optical sheet at an angle larger than 45° and smaller than 135° as viewed from the front direction.

In the display device according to one aspect of the present invention, the transmissive display unit may include a lower light polarizing plate and an upper light polarizing plate disposed on the light outgoing side of the lower light polarizing plate, and the transmission axis of the lower polarizing plate may be parallel to the arrangement direction of the unit shaped elements of the optical sheet.

### BRIEF DESCRIPTION OF THE DRAWINGS

FIG. 1 is a perspective view showing the schematic construction of a transmissive display device and a surface light source device according to an embodiment of the present invention;

FIG. 2 is a cross-sectional view taken along the line II-II of FIG. 1, illustrating an optical sheet incorporated into the surface light source device of FIG. 1;

FIG. 3 is an enlarged view of the optical sheet of FIG. 2 in the same cross-section as FIG. 2;

FIG. 4 is a graph showing change in the transmittance of light depending on light outgoing surface angle;

FIG. 5 is an enlarged view of the optical sheet of FIG. 2 in the same cross-section as FIG. 2;

FIG. 6 is a cross-sectional view taken along the line VI-VI of FIG. 1, illustrating a light colleting sheet incorporated into the surface light source device of FIG. 1;

FIG. 7 is a graph showing the angular distribution of luminance in the case where the body portion of an optical sheet has an anisotropic diffusion function and the angular distribution of luminance in the case where the body portion does not have an anisotropic diffusion function;

FIG. 8 is a diagram illustrating a variation of the optical sheet of FIG. 2 in the same cross-section as FIG. 2;

FIG. 9 is a diagram illustrating another variation of the optical sheet of FIG. 2 in the same cross-section as FIG. 2; and

FIG. 10 is a perspective view equivalent to FIG. 1, showing the schematic construction of a variation of the transmissive display device and the surface light source device.

### DETAILED DESCRIPTION OF THE PREFERRED EMBODIMENTS

Preferred embodiments of the present invention will now be described with reference to the drawings. In the drawings, for the sake of illustration and easier understanding, scales, horizontal to vertical dimensional ratios, etc. are exaggeratingly modified from those of the real things.

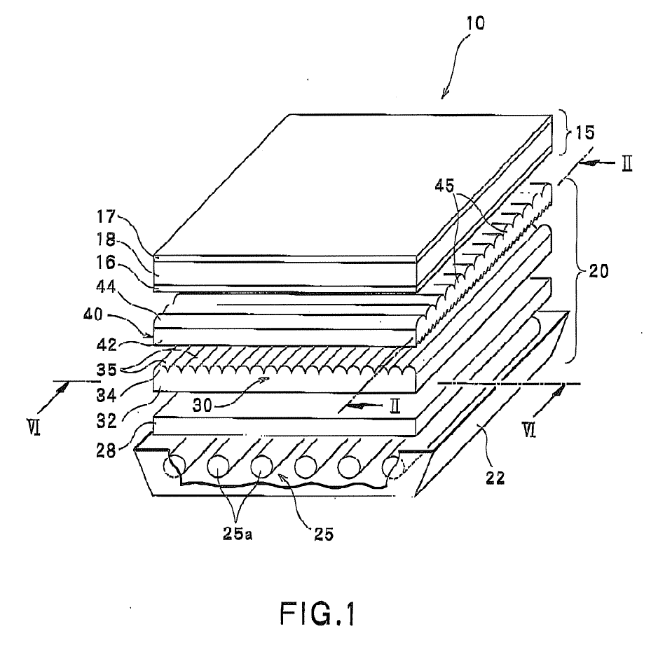

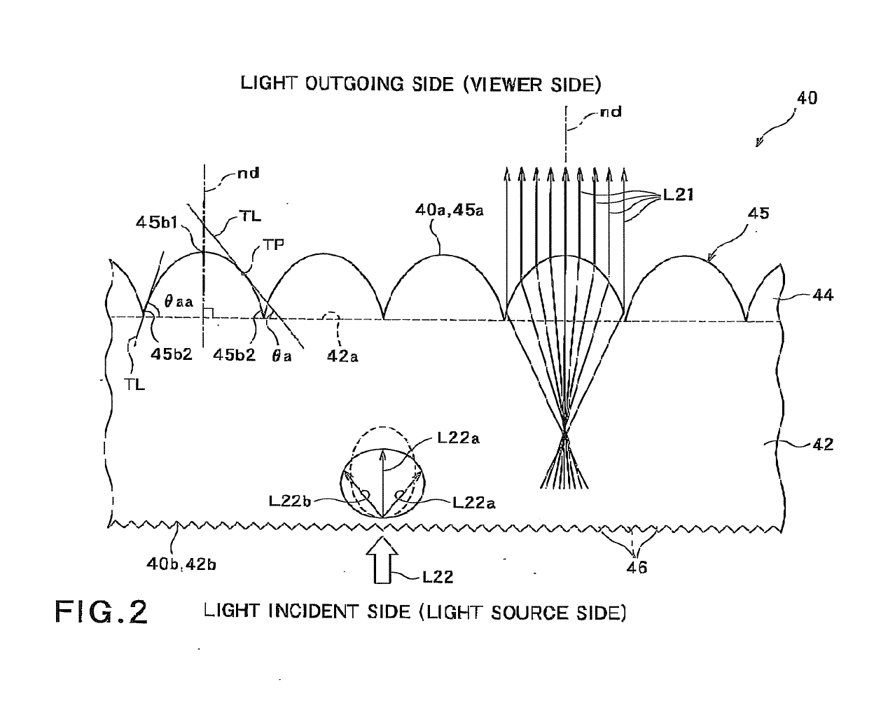

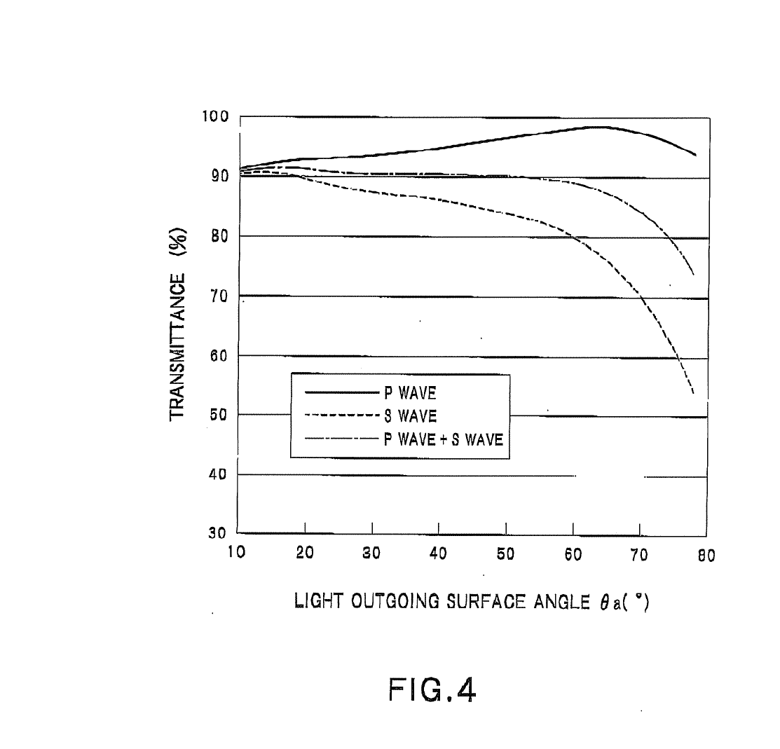

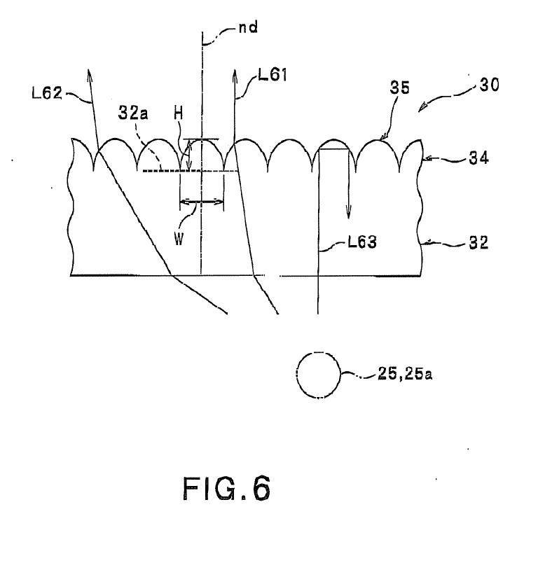

FIGS. 1 through 7 are diagrams illustrating an embodiment of the present invention. Of these, FIG. 1 is a schematic perspective view of a transmissive display device and a surface light source device. FIGS. 2, 3 and 5 are cross-sectional views in main cross-sections, showing an optical sheet. FIG. 4 is a graph showing the transmittance of incident light, incident on the light outgoing surface of a unit shaped element at such an angle that the light is allowed to outgo in the front direction through refraction at the light outgoing surface, in relation to the light outgoing surface angle. FIG. 6 is a cross-sectional view in a main cross-section, showing a light colleting sheet (light condensing sheet).

The transmissive display device 10 shown in FIG. 1 includes a transmissive display unit 15 and a surface light source device 20, disposed on the back side of the transmissive display unit 15, for illuminating the transmissive display unit 15 from the back. The transmissive display unit 15 is an image-forming device and functions as a shutter which controls transmission and blocking of light from the surface light source device 20 for each pixel.

In this embodiment the transmissive display unit (transmissive display section) 15 is comprised of a liquid crystal panel (liquid crystal cell). Thus, the transmissive display unit 15 functions as a liquid crystal display device. The liquid crystal panel (transmissive display unit) 15 includes a pair of polarizing plates 16, 17 and a liquid crystal layer 18 sandwiched between the pair of polarizing plates. The polarizing plates 16, 17 function to convert incident light into two orthogonal polarization components (P wave and S wave), and allow transmission of one polarization component (e.g. P wave) in one direction (direction parallel to the transmission axis) and absorb the other polarization component (e.g. S wave) in the other direction (direction parallel to the absorption axis) orthogonal to the one direction.

An electric field can be applied to each pixel area of the liquid crystal layer 18. The orientation of the liquid crystal layer 18 changes upon the application of an electric field. A particular direction polarized light (P wave in this embodiment) which has passed through the lower polarizing plate 16 disposed on the light incident side (light entrance side, light inputting side), turns its polarization direction by 90 degrees when the particular direction polarized light passes through the liquid crystal layer 18 to which an electric field is being applied, whereas the particular polarized light maintains its polarization direction when the particular passes through the liquid crystal layer 18 to which no electric field is being applied. Therefore, transmission through or absorption and blocking by the upper polarizing plate 17, disposed on the light outgoing side (light exiting side, light emerging side) of the lower polarizing plate 16, of the particular direction polarized light (P wave) which has passed through the lower polarizing plate 16, can be controlled by application or no application of an electric field to the liquid crystal layer 18.

The liquid crystal panel (transmissive display unit) 15 can thus control transmission or blocking of light from the surface light source device 20 for each pixel. The construction of the liquid crystal panel (liquid crystal cell) can be the same as a conventional device (member) incorporated in a conventional liquid crystal display device, and hence a further detailed description thereof will be omitted.

The term “light outgoing side (light exiting side, light emerging side)” herein refers to downstream side (viewer side, upper side in FIGS. 1, 2, 3 and 5) in the direction of light that travels from a light source 25 toward a viewer, passing through an optical sheet 40, etc., without turning back. The term “light incident side (light entrance side, light inputting side)” herein refers to upstream side (lower side in FIGS. 2, 3 and 5) in the direction of light that travels from the light source 25 toward a viewer, passing through the optical sheet 40, etc., without turning back.

The surface light source device 20 will now be described. As shown in FIG. 1, the surface light source device 20 includes the light source 25 and the optical sheet 40 which allows light from the light source 25 to pass therethrough. In this embodiment the optical sheet 40 is disposed on the outermost light outgoing side of the surface light source device 20 and constitutes a light emitting surface (light outgoing surface, light exiting surface). The optical sheet 40 lies adjacent to the lower polarizing plate 16 of the transmissive display unit 15. In the embodiment shown in FIG. 1, the surface light source device 20 also includes a light colleting sheet (also called light incident side optical sheet) 30, disposed on the light incident side of the optical sheet 40, for collecting (condensing) light, and a light diffusing sheet 28, disposed on the light incident side of the light colleting sheet 30, for diffusing light.

While the surface light source device 20 can be constructed in various forms such as, for example, an edge light (side light) type, the surface light source device 20 is constructed as a direct-type backlight unit in this embodiment. Thus, the light source 25 is disposed on the light incident side of the optical sheet 40 such that the light source 25 is opposed to the optical sheet 40. Further, the light source 25 is covered with a reflective plate 22 from the back. The reflective plate 22 is formed in a box shape having an opening (window) on the optical sheet 40 side.

The terms “sheet”, “film” and “plate” are not used herein to strictly distinguish them from one another. Thus, the term “sheet” includes a member which can also be called film or plate.

In this embodiment the light source 25 includes a plurality of linear light emitters 25a. The linear light emitters 25a are arranged such that their longitudinal directions are parallel to each other. Each light emitter 25a is, for example, comprised of a fluorescent tube such as a cold-cathode tube. Various other types of light emitters, such as point-like LEDs (light emitting diodes) or incandescent bulbs, a planar EL (electroluminescence) light emitter, etc. may also be used for the light source 25.

As shown in FIG. 1, the reflective plate 22 is a member to direct light from the light source 25 toward the optical sheet 40. At least the inner surface of the reflective plate 22 is made of a material having a high reflectance, such as a metal.

The light diffusing sheet 28 will now be described. The light diffusing sheet 28 is a sheet-like member for diffusing incident light preferably isotropically so as to reduce luminance variation (also called tube-derived contrast lines) due to the construction of the light source 25, and equalize the in-plane luminance distribution, thereby obscuring the image of the light source 25. For such a light diffusing sheet 28 may be used a sheet comprising a base and light diffusing particles dispersed in the base and having a light diffusing function. A light diffusing function can be imparted to the light diffusing sheet 28 e.g. by using light diffusing particles of a high-reflectance material, or by using light diffusing particles having a different refractive index from the refractive index of the base material.

The light colleting sheet 30 will now be described. As shown in FIGS. 1 and 6, the light colleting sheet 30 includes a sheet-like body portion 32 and a lens portion 34 positioned on the light outgoing side of the body portion 32. The lens portion 34 is comprised of a large number of unit shaped elements (unit optical elements) 35 arranged side-by-side on the light outgoing side surface 32a of the sheet-like body portion 32. The light colleting sheet 30 has a function (light collecting function, light condensing function) that change the direction of incident light in such a manner as to collect (condense) the outgoing light (exiting light) in the front direction (normal direction) nd, thereby enhancing the luminance in the front direction in a focused way.

The unit shaped elements 35 are arranged side-by-side on the light outgoing side surface 32a of the sheet-like body portion 32. As shown in FIG. 1, the unit shaped elements 35 extend linearly in a direction intersecting the arrangement direction of the unit shaped elements 35. In this embodiment the unit shaped elements 35 extend in a straight line. Further, the longitudinal direction of the unit shaped elements 35 is, on a plane parallel to the sheet plane of the body portion 32, perpendicular to the arrangement direction of the unit shaped elements 35. As shown in FIG. 1, in this embodiment the arrangement direction of the unit shaped elements 35 is perpendicular to the longitudinal direction of the light emitters 25a of the light source 25, and the longitudinal direction of the unit shaped elements 35 is parallel to the longitudinal direction of the light emitters 25a.

As shown in FIG. 6, in this embodiment the cross-sectional shape of each unit shaped element 35 in a cross-section which is parallel to both the normal direction nd of the body portion 32 and the arrangement direction of the unit shaped elements 35 (also referred to as “main cross-section of light colleting sheet”), is constant along the longitudinal direction (direction in which the component 35 extends linearly) of the unit shaped element 35. The unit shaped elements 35, forming the lens portion 34, all have the same construction. In the embodiment shown, each unit shaped element 35 has a shape corresponding to part of an ellipse or a circle in a main cross-section of the light colleting sheet. However, the construction of the unit shaped elements 35 is not limited to the construction shown, and may be modified according to the construction of the surface light source device 20 other than the light colleting sheet 30, for example, the construction of the light source 25.

In a specific embodiment of the unit shaped elements 35 thus constructed, the width W of each unit shaped element 35 (see FIG. 6) may be 1 μm to 200 μm. The protruding height H (see FIG. 6) of each unit shaped element 35 from the light outgoing side surface 32a of the body portion 32, along the normal direction nd to the sheet plane of the light colleting sheet 30, may be 0.25 μm to 50 μm. It has been found through the present inventors' experiments that in a main cross-section of the light colleting sheet, the width of the unit shaped element 35 of the light colleting sheet 30, along a direction parallel to the sheet plane of the body portion 32, is preferably made not less than 1.8 times and not more than 2.3 times the height H of the unit shaped element 35 from the body portion 32 along the normal direction rid of the body portion 32, in terms of combination with the below-described optical sheet 40. There is a significant lowering of the front direction luminance when the width W and the height H of the unit shaped elements 35 are set outside the range.

The term “sheet plane (film plane, plate plane)” herein refers to a plane which coincides with the planar direction of an objective sheet-like member when taking a wide and global view of the sheet-like member. In this embodiment the sheet plane of the body portion 32 of the light colleting sheet 30, the sheet plane of the body potion 42 of the below-described optical sheet 40, the sheet plane of the light diffusing sheet 28, the light emitting surface of the surface light source device 20 and the display surface of the transmissive display device 10 are parallel to each other. The term “front direction” herein refers to the normal direction nd (see e.g. FIG. 2) to the sheet plane of the optical sheet 40, and also coincides with the normal direction of the sheet plane of the light colleting sheet 30, the normal direction of the light emitting surface of the surface light source device 20, etc.

The optical sheet 40 will now be described. As shown in FIG. 1, in this embodiment the construction of the optical sheet 40 is similar to the construction of the above-described light colleting sheet 30 except that the optical sheet 40 is provided with the below-described unit lenses 46. The optical sheet 40 includes a sheet-like body portion 42 and a lens portion 44 positioned on the light outgoing side of the body portion 42. The lens portion 44 is comprised of a large number of unit shaped elements (unit optical elements, unit lenses) 45 arranged side-by-side on the light outgoing side surface 42a of the sheet-like body portion 42. In this embodiment the unit shaped elements 45 are arranged, with no space therebetween, on the light outgoing side surface 42a of the body portion 42. Thus, the light outgoing surface 40a of the optical sheet 40 is constituted solely by the light outgoing surfaces 45a of the unit shaped elements 45.

The optical sheet 40 has a polarization separation function that allows a particular polarization component (P wave in this embodiment) of transmitted light, which is refracted and exits in the front direction, to selectively transmit through the optical sheet 40 while selectively reflecting a polarization component (S wave in this embodiment) other than the particular polarization component. In this embodiment the optical sheet 40 also has a function (light collecting function) which, as with the light colleting sheet 30, changes the direction of incident light in such a manner as to collect (condense) the exiting light in the front direction (normal direction) nd, thereby enhancing the luminance in the front direction in a focused way.

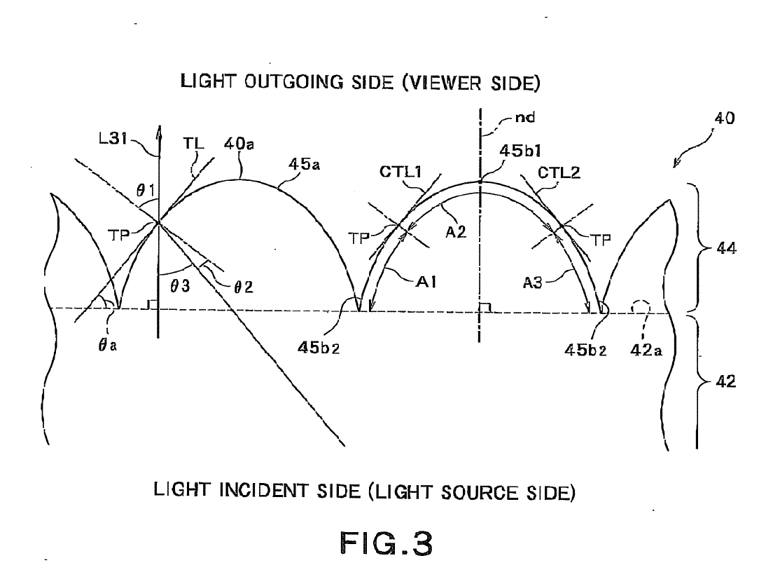

FIGS. 2 and 3 show the optical sheet 40 in a crass-section which is parallel to both the normal direction nd of the body portion 42 and the arrangement direction of the unit shaped elements 45 (also referred to as “main cross-section of optical sheet”). The cross-section shown in FIGS. 2 and 3 corresponds to the cross-section taken along the line II-II of FIG. 1.

As shown in FIGS. 2 and 3, the body portion 42 functions as a sheet-like member that supports the unit shaped elements 45. As shown in FIGS. 1 and 2, in this embodiment the unit shaped elements 45 are arranged side-by-side, with no space therebetween, on the light outgoing side surface 42a of the body portion 42, and forms the lens portion 44 on the body portion 42.

The body portion 42 also has an anisotropic diffusion function that allows transmitted light to diffuse mainly in the arrangement direction of the unit shaped elements 45. In this embodiment, as shown in FIG. 2, unit lenses 46 are formed on the light incident side surface 42b of the body portion 42. The light diffusing function is imparted to the body portion 42 by the unit lenses 46. In this embodiment the unit lenses 46 are arranged side-by-side with no space therebetween, and thus the light incident surface 40b of the optical sheet 40 is comprised solely of the unit lenses 46.

The term “lens” herein includes a lens in the narrow sense, having a curved surface(s) such as a spherical surface, and a so-called prism having flat surfaces, and also broadly includes an optical element having a curved surface(s) and/or a flat surface(s).

The unit lenses 46 each extend linearly (in a straight line in this embodiment) in a direction intersecting the arrangement direction of the unit lenses 46. In this embodiment the longitudinal direction of the unit lenses 46 is, on a plane parallel to the sheet plane of the body portion 42, perpendicular to the arrangement direction of the unit lenses 46. As shown in FIGS. 1 and 2, on a plane parallel to the sheet plane of the body portion 42, the arrangement direction of the unit lenses 46 intersects the longitudinal direction of the unit shaped elements 45 of the optical sheet 40, which will be described in detail later, at an angle larger than 45° and smaller than 135°. Particularly in this embodiment, the arrangement direction of the unit lenses 46 is parallel to the arrangement direction of the unit shaped elements 45 of the optical sheet 40. Therefore, the diffusion function of the body portion 42, performed by the parallel-arranged unit lenses 46, has the anisotropy of diffusion; light is diffused mainly in the arrangement direction of the unit shaped elements 45.

As shown in FIG. 2, in this embodiment each unit lens 46 has a triangular shape (prism shape) in a cross-section perpendicular to the longitudinal direction. The cross-sectional shape of each unit lens 46 is constant along the longitudinal direction (direction in which the lens 46 extends linearly) of the unit lens 46. The unit lenses 46 all have the same shape.

The construction of the unit lenses 46, constituting the light incident side surface 42b of the body portion 42, is not particularly limited insofar as it can form a rough surface, which can diffuse light, in the light incident side surface 42b of the body portion 42. The “rough surface” herein refers to a rough surface in an optical sense. Thus, the light incident side surface 42b of the body portion 42 (the light incident surface 40b of the optical sheet 40) will sufficiently fall into “rough surface” if the 10-point average roughness Rz (JIS B0601) of the surface 42b is not less than the shortest visible light wavelength (0.38 μm).

The unit shaped elements 45 will now be described in detail. As shown in FIG. 1, the unit shaped elements 45 each extend linearly in a direction intersecting the arrangement direction of the unit shaped elements 45. In this embodiment the unit shaped elements 45 extend in a straight line. Further, the longitudinal direction of the unit shaped elements 45 is, on a plane parallel to the sheet plane of the body portion 42, perpendicular to the arrangement direction of the unit shaped elements 45. As shown in FIG. 1, in this embodiment the arrangement direction of the unit shaped elements 45 is parallel to the longitudinal direction of the light emitters 25a of the light source 25, and the longitudinal direction of the unit shaped elements 45 is perpendicular to the longitudinal direction of the light emitters 25a. Further, as shown in FIG. 1, in this embodiment the arrangement direction of the unit shaped elements 45 of the optical sheet 40 is perpendicular to the arrangement direction of the unit shaped elements 35 of the light colleting sheet 30. Further, as described above, the arrangement direction of the unit shaped elements 45 of the optical sheet 40 is parallel to the arrangement direction of the unit lenses 46 constituting the light incident surface 42b of the body portion 42 of the optical sheet 40.

As viewed from the front direction, the longitudinal direction of the unit shaped elements 45 of the optical sheet 40 intersects the transmission axis of the lower polarizing plate 16 of the transmissive display unit 15. Preferably, on a plane parallel to the display surface of the display device 10 (plane parallel to the sheet plane of the body portion 42 of the optical sheet 40), the longitudinal direction of the unit shaped elements 45 of the optical sheet 40 intersects the transmission axis of the lower polarizing plate 16 of the transmissive display unit 15 at an angle larger than 45° and smaller than 135°. Particularly in this embodiment, the longitudinal direction of the unit shaped elements 45 of the optical sheet 40 is perpendicular to the transmission axis of the lower polarizing plate 16 of the transmissive display unit 15, and the arrangement direction of the unit shaped elements 45 of the optical sheet 40 is parallel to the transmission axis of the lower polarizing plate 16 of the transmissive display unit 15.

As shown in FIG. 1, in this embodiment the cross-sectional shape of each unit shaped element 45 in a main cross-section of the optical sheet is constant along the longitudinal direction (direction in which the unit shaped element 45 extends linearly) of the unit shaped element 45. The unit shaped elements 45, constituting the lens portion 44 of the optical sheet 40, all have the same construction. The cross-sectional shape of each unit shaped element 45 in a main cross-section will be described in more detail below.

As shown in FIGS. 2 and 3, in this embodiment each unit shaped element 45 has a tapered cross-sectional shape in a main cross-section of the optical sheet. That is to say, in a main cross-section, the width of each unit shaped element 45, along a direction parallel to the sheet plane of the body portion 42, decreases with distance from the body portion 42 along the normal direction nd of the body portion 42.

As shown in FIG. 3, in a main cross-section of the optical sheet, the outline of each unit shaped element 45 is composed of three or more joined arcs (circular or elliptic arcs), in particular three elliptic arcs A1, A2, A3 in this embodiment. Adjacent two joined arcs (arcs A1, A2 or arcs A2, A3) have a common tangent CTL1 or CTL2 at their joint. Thus, adjacent two arcs are joined continuously. This enables gentle change in the angular distribution of luminance at the light outgoing surface 40a of the optical sheet 40, thereby preventing a rapid change in brightness (cut-off) as observed upon a change of viewing direction.

In this embodiment the outline of each unit shaped element 45 in a main cross-section of the optical sheet is line-symmetrical with respect to a symmetry axis which is parallel to the normal direction nd of the body portion 42. Therefore, the luminance at the light outgoing surface 40a of the optical sheet 40 has an angular distribution which is symmetrical with respect to the front direction in a plane parallel to the arrangement direction of the unit shaped elements 45.

As shown in FIG. 2, in a main cross-section, the angle θa (also referred to as “light outgoing surface angle”) of a tangent TL to the outline of each unit shaped element 45 with respect to the sheet plane of the body portion 42 (the light outgoing side surface 42a of the body portion 42 in this embodiment) increases as the tangent point TP between the tangent TL and the unit shaped element 45 moves from the top 45b1 of the outline (light outgoing surface) 45a of the unit shaped element 45, the farthest point from the body potion 42 in the normal direction nd of the body portion 42, toward either end 45b2 of the outline (light outgoing surface) 45a of the unit shaped element 45. The term “increase” in the light outgoing surface angle θa herein not only refers to constant increase in the light outgoing surface angle θa (as in this embodiment as shown in FIGS. 2 and 3) but also includes a case where there is no change in the light outgoing surface angle θa at least in a certain region. Thus, the “increase” in the light outgoing surface angle θa herein implies that there is “no decrease” in the light outgoing surface angle θa as the tangent point TP moves from the top 45b1 of the outline (light outgoing surface) 45a toward either end 45b2 of the outline (light outgoing surface) 45a.

Based on the results of studies by the present inventors, the light outgoing surface angle θa of each unit shaped element is preferably set as follows: First, in a main cross-section of the optical sheet, the light outgoing surface angle θaa (also referred to as “light outgoing surface bottom angle”) of the tangent TL to one end 45b2 of the outline of a unit shaped element 45 with respect to the sheet plane of the body portion 42 is preferably not less than 55°, more preferably not less than 65°. It has been confirmed by the present inventors that when the light outgoing surface bottom angle θaa is not less than 55°, the front direction luminance can be enhanced to a visually discernible extent. The front direction luminance can be further appreciably enhanced when the light outgoing surface bottom angle θaa is not less than 65°. On the other hand, the light outgoing surface bottom angle θaa of each unit shaped element 45 is preferably not more than 75°. While the front direction luminance can thus be enhanced by increasing the light outgoing surface bottom angle θaa, the increase in the front direction luminance will cease or the front direction luminance will rather decrease if the light outgoing surface bottom angle θaa is made too large. In addition, if the light outgoing surface bottom angle θaa is made too large, the spectral distribution of transmitted light will become uneven, leading to a lowering in the color reproducibility of the display device 10.

Further, in a main cross-section of the optical sheet 40, the tangent TL in contact with the outline of the unit shaped element 45 at a position which is displaced from the end 45b2 of the unit shaped element 45 by a distance corresponding to 15% of the width of the unit shaped element 45 in a direction parallel to the sheet plane of the body portion 42, preferably makes an angle θa of not less than 40° with the sheet plane of the body portion 42. That is to say, the light outgoing surface angle θa of the unit shaped element 45, at a position which is displaced from the end 45b2 of the unit shaped element 45 by a distance corresponding to 15% of the width of the unit shaped element 45 in a direction parallel to the sheet plane of the body portion 42, is preferably not less than 40°. Studies by the present inventors have revealed that when the light outgoing surface angle as is not less than 40°, the optical sheet can possess a polarization separation function which ensures a visible enhancement of the front direction luminance, as will be described in detail later. Further, when the light outgoing surface in an area that accounts for at least 30% of the entire display area has the light outgoing surface angle θa of not less than 40°, a visible enhancement of the front direction luminance can be attained in the display device 10.

Further, in a main cross-section of the optical sheet, a tangent TL to the outline of the unit shaped element 45 preferably makes an angle θa of not more than 15° with the sheet plane of the body portion 42 when the tangent point TP between the tangent TL and the outline of the unit shaped element 45 lies in a region that accounts for at least 15% of the full width of the unit shaped element 45 in a direction parallel to the sheet plane of the body portion 42. That is to say, in a region that accounts for not less than 15% of the unit shaped element 45 in a direction parallel to the sheet plane of the body portion 42, the light outgoing surface angle θa of the unit shaped element 45 is preferably not less than 0° and not more than 15°. As described above, in this embodiment the cross-sectional shape of the unit shaped element 45 in a main cross-section of the optical sheet is line-symmetrical, and the light outgoing surface angle θa increases from the top 45b1 toward either end 45b2. Thus, in other words, the tangent TL in contact with the outline of the unit shaped element 45 at a position which is displaced from the top 45b1 of the unit shaped element 45 by a distance corresponding to 7.5% of the width of the unit shaped element 45 in a direction parallel to the sheet plane of the body portion 42, preferably makes an angle θa of not more than 15° with the sheet plane of the body portion 42. Studies by the present inventors have revealed that when the optical sheet is thus configured, of light which travels toward the end 45b2 of the unit shaped element 45 in a direction parallel to a main cross-section of the optical sheet, and part of which is refracted at the light outgoing surface 45a of the unit shaped element 45 and outgoes (exits) in the normal direction nd of the body potion 42, the other part of the light, which is reflected from the light outgoing surface 45a of the unit shaped element 45 without refraction, tends to either later outgo from the unit shaped element 45 at an light outgoing angle (angle of the direction of outgoing light with respect to the normal direction of the optical sheet) of not less than 80° or, after outgoing from the unit shaped element, enter an adjacent unit shaped element.

In a specific embodiment of the unit shaped elements 45 thus constructed, the width of each unit shaped element 45 may be 1 μm to 200 μm. The protruding height of each unit shaped element 45 from the light outgoing side surface 42a of the body portion 42, along the normal direction nd to the sheet plane of the optical sheet 40, may be 0.25 μm to 50 μm.

The terms used herein to specify shapes or geometric conditions, such as “circle”, “ellipse”, “perpendicular”, etc., should not be bound to their strict sense, and should be construed to include equivalents or resemblances for which the same optical function or effect can be expected.

The light colleting sheet 30 and the optical sheet 40, having the above-described constructions, can be easily produced e.g. by extrusion processing or by shaping the unit shaped elements 35, 45 on the respective substrates. While a variety of materials can be used for the light colleting sheet 30 and the optical sheet 40, preferably used are those materials which are widely used for optical sheets (light colleting sheets) to be incorporated into display devices, and which have excellent mechanical properties, optical properties, stability, processability, etc., and which are available at a low cost. Examples of such materials include a transparent resin mainly comprising at least one of acrylate, styrene, polycarbonate, polyethylene terephthalate, acrylonitrile, etc., and a reactive resin (e.g. ionizing radiation-curable resin) such as a polyepoxy acrylate resin or a polyurethane acrylate resin. When such a material is used for the optical sheet 40 and the light colleting sheet 30, the unit shaped elements 35, 45 will have a refractive index in the range of 1.45 to 1.60.

The operations of the optical sheet 40, the surface light source device 20 and the transmissive display device 10 will now be described.

First, the overall operation of the transmissive display device 10 and the surface light source device 20 will be described.

Light emitted from the light emitters 25a of the light source 25 travels toward the viewer side directly or after reflecting from the reflective plate 22. The light, traveling toward the viewer side, is isotropically diffused by the light diffusing sheet 28 and then enters (is incident on) the light colleting sheet 30.

As shown in FIG. 6, lights L61, L62 that exit from the unit shaped elements 35 of the light colleting sheet 30 are refracted at the light outgoing surfaces (lens surfaces) of the unit shaped elements 35 of the light colleting sheet 30. Due to the refraction, the lights L61, L62 each traveling in a direction inclined from the front direction nd are bent such that the angle of the direction (exit direction) of each light with respect to the normal direction nd to the sheet plane of the light colleting sheet 30 becomes smaller. Owing to such effect of the light colleting sheet, the unit shaped elements 35 can collect (condense) transmitted light in the front direction nd. The unit shaped elements 35 thus exert a collecting effect (condensing effect) on transmitted light.

The light collecting effect of the unit shaped elements 35 is exerted more significantly for light that travels in a direction more inclined from the front direction nd. Therefore, though depending on the degree of light diffusion by the light diffusing sheet 28 disposed nearer to the light source than the light colleting sheet 30, the front direction luminance can be more effectively enhanced in a region, lying farther away from the light emitters 25a of the light source 25, where most light from the light emitters 25a of the light source 25 tend to enter at a large incident angle (see light L62 of FIG. 6).

On the other hand, as shown in FIG. 6, light 63, traveling in a direction at a small inclination angle with respect to the front direction nd, can repeat total reflections on the light outgoing surface (lens surface) of a unit shaped element 35 and turn toward the light incident side (light source side). Therefore, though depending on the degree of light diffusion by the light diffusing sheet 28 disposed nearer to the light source than the light colleting sheet 30, the luminance can be prevented from becoming too high in a region, lying right above the light source 25, where most light from the light source 25 tend to enter at a small incident angle.

The optical effect of the unit shaped elements 35 on transmitted light thus differs depending on the distance from the light emitters 25a of the light source 25. This can effectively reduce luminance variation (tube-derived contrast lines) produced by the arrangement of the light emitters 25a of the light source 25, thereby obscuring the image of the light source. Thus, the light colleting sheet 30 also has a light diffusing function that equalizes the in-plane luminance. Such a light diffusing function can be performed by arranging the light colleting sheet 30 with respect to the light source 25 such that the longitudinal direction of the unit shaped elements 35 of the light colleting sheet 30 intersects the arrangement direction of the light emitters 25a of the light source 25. Further, such a light diffusing function can be effectively performed by arranging the light colleting sheet 30 with respect to the light source 25 such that the longitudinal direction of the unit shaped elements 35 of the light colleting sheet 30 is perpendicular to the arrangement direction of the light emitters 25a of the light source 25, i.e. the arrangement direction of the unit shaped elements 35 of the light colleting sheet 30 is parallel to the arrangement direction of the light emitters 25a of the light source 25, as shown in FIG. 1.

The outgoing angle of light outgoing (exiting) from the light colleting sheet 30 is thus narrowed down to a narrow angle range about the front direction in a plane parallel to the arrangement direction of the unit shaped elements 35 or the light colleting sheet 30.

Light that has exited from the light colleting sheet 30 enters the optical sheet 40 through the light incident surface 40b of the optical sheet 40. As described above, a large number of linear unit lenses 46 are provided in a linear arrangement (liner array) in the light incident side surface 42a of the body portion 42, constituting the light incident surface 40b of the optical sheet 40. The unit lenses 46 form a rough surface in the light incident surface 40b of the optical sheet 40 and diffuse light incident on the optical sheet 40.

The diffusion by the unit lenses 46 is anisotropic diffusion to a direction parallel to the arrangement direction of the unit lenses 46. Thus, the direction in which light is collected (condensed) by the light colleting sheet 30 disposed on the light incident side of the optical sheet 40 is perpendicular to the direction in which light is diffused by the unit lenses 46 of the optical sheet 40. Therefore, the direction of light which has been collected by the light colleting sheet 30 into the narrow range about the front direction can be prevented from deviating from the range due to the diffusion by the unit lenses 46 of the optical sheet 40. Thus, the ideal angular distribution of luminance at the light outgoing surface of the light colleting sheet 30, in a plane parallel to the arrangement direction of the unit shaped elements 35 of the light colleting sheet 30, can be substantially maintained without being impaired by the light diffusion effect of the unit lenses 46 of the optical sheet 40.

In the optical sheet 40, the transmittance of one polarization component, P wave in this embodiment, of light outgoing in the normal direction nd of the body portion 42 in a plane parallel to the arrangement direction of the unit shaped elements 45 of the optical sheet 40 is enhanced whereas the transmittance of the other polarization component, S wave in this embodiment, is lowered. Thus, the optical sheet 40 exerts a polarization separation effect on light that has been collected by the light colleting sheet 30. The polarization separation effect will be described in detail later. Light that does not pass through the optical sheet 40 reflects in the optical sheet 40, and most of the reflected light turns toward the light incident side. The light that has been returned to the light incident side further repeats reflections, thereby changing its polarization state (for example, S wave turns into P wave). Thus, the reflected light can re-enter the optical sheet 40 and can be utilized.

As with the light colleting sheet 30, the optical sheet 40 also exerts a light collecting effect (condensing effect) on transmitted light through its refraction at the light outgoing surfaces 45a of the unit shaped elements 45. Light whose direction is changed by the optical sheet 40 is a light component which travels parallel to a main cross-section of the optical sheet 40, and thus differs from the light component collected by the light colleting sheet 30. In particular, the light collecting sheet 30 collects light into a narrow angle range about the front direction in a plane parallel to the arrangement direction of the unit shaped elements 35 of the light colleting sheet 30, whereas the optical sheet 40 collects (condenses) light into a narrow angle range about the front direction in a plane parallel to the arrangement direction of the unit shaped elements 45 of the optical sheet 40. Accordingly, the front direction luminance, which has been enhanced by the light colleting sheet 30, is not impaired by the optical effect of the optical sheet 40, and the front direction luminance can be further enhanced by the optical sheet 40.

As described above, the body portion 42 of the optical sheet 40 has a diffusion function that allows light to diffuse mainly in the arrangement direction of the unit shaped elements 45 of the optical sheet 40. The angular distribution of luminance at the light outgoing surface 40a of the optical sheet 40 can therefore be changed gently in a plane parallel to the arrangement direction of the unit shaped elements 45 of the optical sheet 40. Especially because the body portion 42 having a diffusion function is disposed just anterior to the lens portion 44 having a light collecting function (light condensing function), the angular distribution of luminance can be changed very gently and, in addition, a rapid change in the angular distribution of luminance (cut-off) can be effectively prevented.

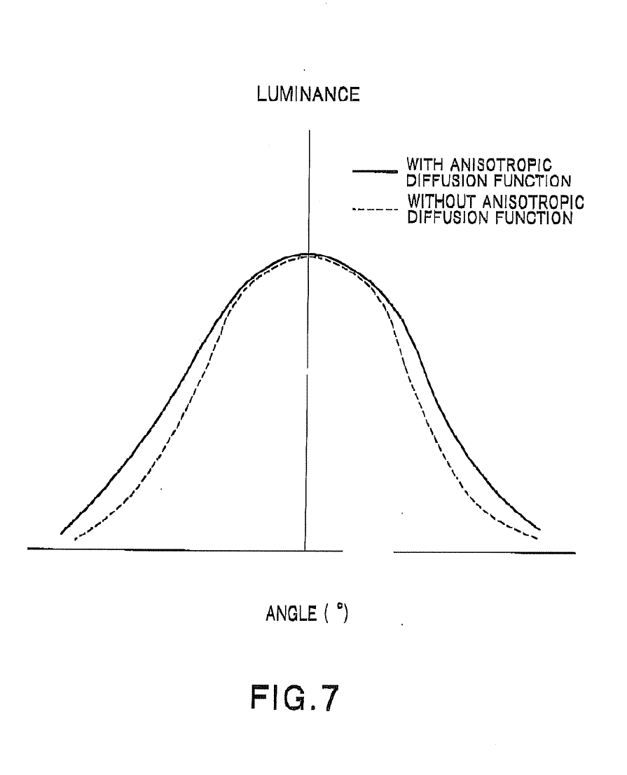

FIG. 7 shows the results of an examination which was conducted to determine the angular distribution of luminance in the case where an anisotropic diffusion function is imparted to the body portion 42 of the optical sheet 40 (shown by the solid line) and the angular distribution of luminance in the case where an anisotropic diffusion function is not imparted to the body portion 42 of the optical sheet 40 (shown by the dashed line). The display device having the above-described construction was used in the examination for the case where an anisotropic diffusion function is imparted to the body portion 42. For the case where an anisotropic diffusion function is not imparted to the body portion 42 was used a display device whose construction is the same as the device used for the case where an anisotropic diffusion function is imparted to the body portion 42, except that the light incident side surface of the body portion of the optical sheet is flat.

Light that has exited from the optical sheet 40 enters the lower polarizing plate 16 of the transmissive display unit 15. The lower polarizing plate 16 allows one polarization component (P wave in this embodiment) of incident light to pass though the lower polarizing plate 16 and absorbs the other polarization component (S wave in this embodiment). Light that has passed through the lower polarizing plate 16 selectively passes through the upper polarizing plate 17 depending on the application of an electric field to each pixel. By thus selectively transmitting light from the surface light source device 20 by means of the transmissive display unit 15, the viewer can view images on the transmissive display device 10.

As described above, the front direction luminance on the light outgoing surface of the surface light source device 20 is enhanced by the light collecting effect of the light colleting sheet 30 and the light collecting effect of the optical sheet 40. Further, due to the polarization separation function of the optical sheet 40, the polarization component (P wave) which can enter the lower polarizing pate 16 of the transmissive display unit 15 is contained at a high proportion in light outgoing in the normal direction nd of the body portion 42 in a plane parallel to the arrangement direction of the unit shaped elements 45 of the optical sheet 40, whereas the polarization component (S wave) which is absorbed by the lower polarizing pate 16 of the transmissive display unit 15 is contained only at a low proportion. That is to say, light outgoing in the normal direction nd of the body portion 42 in a plane parallel to the arrangement direction of the unit shaped elements 45 of the optical sheet 40, contains a high proportion of the component which can be used for the formation of an image on the transmissive display unit 15. Thus, the display device 10 of this embodiment can very effectively enhance the front direction luminance not only by the function (light collecting function) of the unit shaped elements 35, 45 that changes the direction of light into a narrow angle range about the front direction, but also by the improvement in the efficiency in the use of source light due to the polarization separation function of the optical sheet 40 performed on light traveling in the front direction.

The effects produced by the optical sheet 40 will now be described in greater detail.

As is well known, the reflectance of incident light at an interface changes and thus the transmittance at the interface changes depending on the incident angle (angle formed by the normal line to the interface and the incident light) (see e.g. Shigeo Yamaguchi, “Refractive index”, Kyoritsu Shuppan Co., Ltd.). The different polarization components of the incident light, P wave and S wave, have different transmittances (reflectances). The change in the transmittance (reflectance) depending on the incident angle also depends on the refractive indices on both sides of the interface.

The present inventors studied a method to enhance the efficiency in the use of the display device 10 by utilizing such characteristics. The present inventors first focused attention on light which is refracted at the light outgoing surface of an optical sheet and outgoes in the front direction (see light L21 of FIG. 2 and light L31 of FIG. 3). If the efficiency in the use of such light, outgoing in the front direction from the optical sheet 40, in the transmissive display unit 15 can be enhanced, the front direction luminance of the display device 10 will be directly enhanced.

In particular, the present inventors examined the transmittances of lights L21, L31, which are refracted at the light outgoing surface of an optical sheet and outgo in the front direction from the optical sheet, while changing the angle (light outgoing surface angle) θa formed by the light outgoing surface on which the lights L21, L31 are incident and the sheet plane of the optical sheet. As a result, it was found that a difference in the refractive index does not affect the change behavior of the transmittance of light, outgoing in the front direction, depending on the light outgoing surface angle if the refractive index is within the range of the refractive indices (1.45 to 1.60) of widely-used inexpensive materials. That is to say, if the refractive index of an optical sheet is changed by the use of a different material, there is no substantial change in the change behavior of the transmittance of light, outgoing in the front direction, depending on the light outgoing surface angle. FIG. 4 shows the results of an examination for the change behavior of the transmittance of light, outgoing in the front direction, depending on the light outgoing surface angle, carried out using the above-described optical sheet 40 made of a material having a refractive index of 1.49.

The following equations (1) and (2) hold for light which, after entering the optical sheet 40, is refracted by the unit shaped elements 45 and outgoes in the front direction. In the equations (1) and (2), the angles θa, θ1, θ2, θ3 are as shown in FIG. 3. In particular, θ3 is the inclination angle of light traveling in the body portion 42 with respect to the normal direction nd. θ2 is the incident angle of the light with respect to the light outgoing surface 45a of the unit shaped element 45 (inclination angle of the incident direction of the light with respect to the normal direction to the tangent plane to the light outgoing surface 45a of the unit shaped element 45). θ1 is the outgoing angle (exit angle) of the light with respect to the light outgoing surface 45a of the unit shaped element 45 (inclination angle of the outgoing direction (exit direction) of the light with respect to the normal direction to the tangent plane to the light outgoing surface 45a of the unit shaped element 45). The “n” in the equation represents the refractive index of the material of the optical sheet (the unit shaped elements and the body portion).

θa=θ1=θ2+θ3 (1)

n×sin(θ2)=sin(θ1) (2)

By deformation of the equations (1) and (2), the inclination angle θ3 of light traveling in the body portion 42, the incident angle θ2 of the light with respect to the light outgoing surface 45a of the unit shaped element 45, and the outgoing angle θ1 of the light with respect to the light outgoing surface 45a of the unit shaped element 45 can be specified by means of the light outgoing surface angle θa as indicated by the following equations (3) to (5):

θ1=θa (3)

θ2=Arcsin(sin(θ1)/n) (4)

θ3=θ1−Arcsin(sin(θ1)/n) (5)

As shown in FIG. 4, with reference to light that outgoes in the front direction from the optical sheet 40 made of a widely-used inexpensive material (refractive index: 1.45 to 1.60), the transmittance of one polarization component (P wave) is highest when the light outgoing surface angle θa is 62° to 65°. The transmittance of the one polarization component (P wave) decreases as the light outgoing surface angle θa decreases or increases from the peak range of 62° to 65°. On the other hand, the transmittance of the other polarization component (S wave) gradually decreases as the light outgoing surface angle θa increases. That is to say, the smaller the light outgoing surface angle θa is, the higher is the transmittance of the other polarization component (S wave).

As described above, the lower polarizing plate 16 of the transmissive display unit 15 allows only P wave, one polarization component, to pass though it and absorbs S wave, the other polarization component. Therefore, as in the embodiment described herein above, the longitudinal direction of the unit shaped elements 45 of the optical sheet 40 preferably intersects the transmission axis of the lower polarizing plate 16 at an angle larger than 45° and smaller than 135° on a plane parallel to the display surface of the display device 10 (plane parallel to the sheet plane of the body portion 42 of the optical sheet 40). Further, the arrangement direction of the unit shaped elements 45 of the optical sheet 40 is preferably parallel to the transmission axis of the lower polarizing plate 16. Such a construction can enhance the efficiency in the use of source light in the transmissive display unit 15 through adjustment of the light outgoing surface angle θa of the optical sheet 40.

It can be said from the results of FIG. 4 that the light outgoing surface angle θa is preferably set as large as possible to increase the proportion of P wave in transmitted light. The transmittance of P wave can be enhanced by setting the light outgoing surface angle θa as large as possible. Further, the reflectance of S wave can be enhanced by setting the light outgoing surface angle θa as large as possible. This can prevent S wave from being absorbed by the lower polarizing plate 16 of the transmissive display unit 15, enabling the reuse of the S wave.

In this embodiment the light outgoing surface angle θa decreases from the end 45b2 toward the top 45b1. Therefore, in order to set the light outgoing surface angle θa as large as possible in the light outgoing surface of the unit shaped element 45 as a whole, the light outgoing surface bottom angle (light outgoing surface angle at the end 45b2) θaa is preferably set at a large value. In particular, through the present inventors' experiments conducted under varying conditions, it has been found that if the light outgoing surface bottom angle θaa is not less than 55° in the optical sheet 40 made of a widely-used inexpensive material (refractive index: L45 to L60), the provision of the optical sheet 40 between the light colleting sheet 30 and the lower polarizing plate 16 of the transmissive display unit 15 can visibly enhance the front direction luminance as compared to the case of not incorporating the optical sheet into the display device 10. It is thus preferred to set the light outgoing surface bottom angle θaa not less than 55°.

As shown in FIG. 4, in the optical sheet 40 made of a widely-used inexpensive material (refractive index: 1.45 to 1.60), the transmittance of P wave is highest when the light outgoing surface angle θa is 62° to 65°. It is therefore preferred that the largest light outgoing surface angle θa, the light outgoing surface bottom angle θaa, be not less than 65°. This is because when the light outgoing surface bottom angle θaa is not less than 65°, a region which allows passage of P wave at the highest transmittance should be included between the end 45b2 and the top 45b1 in the light outgoing surface 45a of the unit shaped element 45. It is thus highly preferred to set the light outgoing surface bottom angle θaa not less than 65°.

On the other hand, it has been found, through the present inventors' experiments conducted under varying conditions, that too large an light outgoing surface angle θa results in non-uniform spectral distribution of transmitted light. In an optical sheet made of a widely-used inexpensive material (refractive index: 1.45 to 1.60), a visible deterioration in the color reproducibility of the display device 10 may occur when the light outgoing surface angle θa exceeds 75°. Further, when the light outgoing surface angle θa exceeds 75°, there is a rapid decrease in the transmittance of P wave as shown in FIG. 4. With reference to the above-described optical sheet 40, when the light outgoing surface bottom angle θaa exceeds 75°, there is no visible difference in the front direction luminance between the case where the optical sheet 40 is disposed between the light colleting sheet 30 and the lower polarizing plate 16 of the transmissive display unit 15 and the case where the optical sheet 40 is not incorporated into the display device 10. Thus, when the light outgoing surface bottom angle θaa exceeds 75°, it is no longer possible to enhance the front direction luminance to a visually discernible extent by the provision of the optical sheet 40. It is thus preferred to set the light outgoing surface bottom angle θaa not more than 75°.

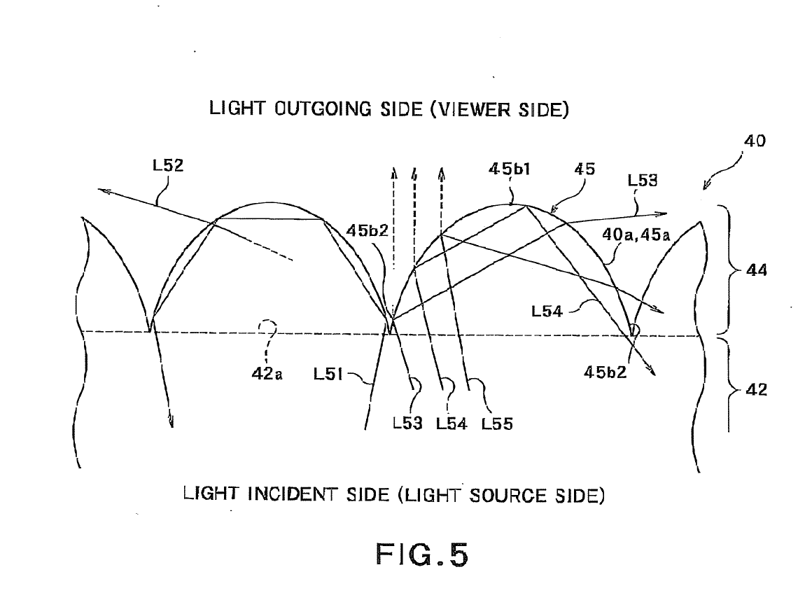

It has also been found, through the present inventors' experiments conducted under varying conditions, that when the light outgoing surface bottom angle θaa exceeds 75°, there exist many light components (e.g. light 52 of FIG. 5) which, after reflecting from the steeply-sloped ends 45b2 of the unit shaped elements 45, are refracted at and outgo from the other region of the light outgoing surfaces 45a of the unit shaped elements 45, as will be described later with reference to FIG. 5. Such light will leak out without being blocked by the transmissive display device 15, leading to a significant lowering of the contrast of images that are displayed on the display device 10. Also in order to prevent the lowering of the contrast of images, the light outgoing surface bottom angle θaa is preferably set not more than 75°.

Further, as described above, the body portion 42 of the optical sheet 40 has a diffusion function that allows light to diffuse mainly in the arrangement direction of the unit shaped elements 45 of the optical sheet 40. The use of such optical sheet 40 makes it possible to very effectively enhance the efficiency in the use of source light.

In general, as indicated by the angular distribution of luminance shown by the dashed line in FIG. 2, light 22 that enters the optical sheet 40 most contains a light component traveling in the front direction, e.g. due to the effect of the reflective plate 22. Such light L22 is diffused in a main cross-section of the optical sheet by the light diffusing action of the body portion 42, whereby the angular distribution of luminance changes, for example, from the angular distribution shown by the dashed line in FIG. 2 to the angular distribution shown by the solid line in FIG. 2. Thus, in a plane parallel to the arrangement direction of the unit shaped elements 45 of the optical sheet 40, due to the light diffusing effect of the body portion 42 of the optical sheet 40, the angular distribution of luminance, having a peak in the front direction and which is within a relatively narrow angle range about the front direction, becomes flatter as a whole with lowering of the peak luminance.

On the other hand, as described above, in the optical sheet 40 made of a widely-used material having a refractive index in the range of 1.45 to 1.60, the polarization separation effect can be most effectively exerted on light 21, which is refracted at the light outgoing surface and outgoes in the front direction, when the light outgoing surface angle θa of the unit shaped element 45 is 62° to 65°. Light that is refracted to the front direction at the light outgoing surface at such an light outgoing surface angle θa (62° to 65°) is one which travels, at an inclination angle θ3 (see FIG. 3) of about 25° to 30° with respect to the normal direction nd of the body portion 45, in the body portion 42 toward the light outgoing surfaces 45a of the unit shaped elements 45 (e.g. lights 22b and 22c shown in FIG. 2).

According to this embodiment, as described above, immediately before light enters the unit shaped elements 45, the direction of the light can be changed by the diffusion effect of the body portion 42 to a direction on which the polarization separation effect of the unit shaped elements 45 can be effectively exerted. Thus, the diffusion function of the body portion 42 can increase the amount of light that is susceptible to the polarization separation effect of the unit shaped elements 45 of the optical sheet 40. This can effectively enhance the light use efficiency, thus making it possible to further enhance the front direction luminance.

It is possible that due to the diffusion function of the body portion 42, light 22a (see FIG. 2) traveling in the front direction will be diffused in a direction other than the front direction, That is to say, the front direction luminance after entry of light into the body portion 42 of the optical sheet 40 will be lower than that before entry of the light into the body portion 42 of the optical sheet 40. However, the unit shaped elements 45, which can perform a light collecting function (light condensing function) through refraction of light at the light outgoing surfaces 45a, are provided on the light outgoing side of the body portion 42. In addition, as described above, the diffusing function of the body portion 42 enables the polarization separation function of the unit shaped elements 45 to be performed highly effectively. The light use efficiency can therefore be effectively enhanced. It thus becomes possible to further enhance the front direction luminance.

In the examination results shown in FIG. 7, there is a slight increase in the front direction luminance by the provision of the anisotropic diffusion function of the body portion 42. In addition, it will be clearly understood from FIG. 7 that the provision of the anisotropic diffusion function of the body portion 42 leads to significant enhancement of the efficiency in the use of source light and to gentler change in the angular distribution of luminance.

As described above, in the unit shaped element 45 in which the light outgoing surface angle θa decreases from the end 45b2 toward the top 45b1, the light outgoing surface angle ea of the unit shaped element 45, at a position which is displaced from the end 45b2 of the unit shaped element 45 by a distance corresponding to 15% of the width of the unit shaped element 45 in a direction parallel to the sheet plane of the body portion 42, is preferably not less than 40°. Studies by the present inventors have revealed that an optical sheet made of a widely-used inexpensive material (refractive index: 1.45 to 1.60) can perform a polarization separation function, capable of ensuring a visible enhancement of the front direction luminance, when the light outgoing surface angle θa is set not less than 40°. Further, when the light outgoing surface in an area that accounts for at least 30% of the entire display area has the light outgoing surface angle θa of not less than 40°, a visible enhancement of the front direction luminance can be attained in the display device 10. Specifically, a 5% increase in the front direction luminance has been confirmed by measurement.

While the use of the optical sheet 40 having the unit shaped elements 45 can enhance the front direction luminance, such an optical sheet can produce a small luminance peak in a relatively large light outgoing angle range (e.g. 60°-75°) different from the front direction. Such a luminance peak formed at a large light outgoing angle, called side lobe, cannot be effectively used in a display device. Thus, the generation of such light lowers the light source energy efficiency (efficiency in the use of light source). Furthermore, such light cannot be fully blocked by a liquid crystal display panel (LCD panel), a typical transmissive display unit. Thus, such light leaks out of a liquid crystal display panel. This lowers the contrast of images, for example a black image, displayed on the display panel, thus worsening the image quality.

The following is considered to be the cause of the formation of such a luminance peak other than the front direction peak: As shown in FIG. 5, light entering the unit shaped elements 45 includes light that reflects from the light outgoing surfaces 45a of the unit shaped elements 45 without passing through the surfaces 45a. Light L51, a light component of such light, repeats reflections on the light outgoing surface 45a of a unit shaped element 45, and turns toward the light incident side. Such light also contains a light component L52 which, after reflecting from the light outgoing surface 45a of a unit shaped element 45a, is refracted at and outgoes from the other region of the light outgoing surface 45a of the unit shaped element 45a. Such light L52 is considered to form a side lobe. This has been confirmed by simulation. Further, this consideration is consistent with the fact that side lobe is pronounced in a prism sheet having two flat light outgoing surfaces.

In this embodiment S wave, one polarization component, is reflected at a higher reflectance than normal. As shown in FIG. 4, the reflectance of S wave increases with increase in the light outgoing surface angle θa. Accordingly, S wave is reflected at the highest reflectance when entering the end 45b2 or its vicinity, where the light outgoing surface angle θa is largest, of a unit shaped element 45.

On the other hand, as described above, in this embodiment in a main cross-section of the optical sheet, the light outgoing surface angle θa is made not more than 15° in a region, centered at the top 45b1, which accounts for at least 15% of the full width of each unit shaped element 45. Thus, the region of the light outgoing surface 45a, having a very small light outgoing surface angle θa, is provided about the top 45b1. Accordingly, if the amount of light which is reflected in the unit shaped elements 45 is increased by reflection of S wave due to the polarization separation effect, the occurrence of side lobe can be effectively prevented.

More specifically, light L53 which has entered the end 45b2 of a unit shaped element 45 is once reflected at the highest reflectance from the light outgoing surface 45a of the unit shaped element 45, and then enters a region of the light outgoing surface 45a where the light outgoing surface angle θa is not more than 15° or otherwise relatively small. Similarly, light L54, entering the unit shaped element 45 at a position somewhat displaced from the end 45b2 toward the top 45b1, is once reflected from the light outgoing surface 45a of the unit shaped element 45, and then enters a region of the light outgoing surface 45a where the light outgoing surface angle θa is not more than 15° or otherwise relatively small. The light L53, L54 is then refracted and outgoes at a very large light outgoing angle, or is totally reflected and returns toward the light incident side.

It has been found through the present inventors' experiments that light outgoing at an light outgoing angle of not less than 80° is not useful, but does not deteriorate images on the transmissive display unit 15 to a visually discernible extent. Further, in the case where in a main cross-section of the optical sheet, the light outgoing surface angle θa is not more than 15° in a region containing the top 45b1 and which accounts for at least 15% of the full width of the unit shaped element 45, the light L53 which travels toward the and 45b2 of the unit shaped element 45 at an incident angle that allows the light, to be refracted to the front direction, and is reflected at the end 45b2, either later outgoes from the unit shaped element 45 at an light outgoing angle of not less than 80° or, after outgoing from the unit shaped element 45, enters an adjacent unit shaped element.

In the unit shaped element 45 in which the light outgoing surface angle θa decreases from the end 45b2 toward the top 45b1, light L55 which, at an incident angle that allows the light to be refracted to the front direction, enters the light outgoing surface 45a in a region lying at a distance from the end 45b2 of the unit shaped element 45, is unlikely to cause side lobe. Such light L55 enters the light outgoing surface 45a of the unit shaped element 45 at a relatively small incident angle. Therefore, when the light enters the light outgoing surface 45a of the unit shaped element 45, it is reflected only in a small amount, as shown in FIG. 4. Further, the small amount of reflected light, in most cases, turns toward the light incident side and re-enters the body portion 42 or enters an adjacent unit shaped element. For these reasons, light L55 which, at an incident angle that allows the light to be refracted to the front direction, enters the light outgoing surface 45a in a region (e.g. in the vicinity of the top 45b1) lying at a distance from the end 45b2 of the unit shaped element 45, is unlikely to cause side lobe in this embodiment.

Light entering the light outgoing surfaces 45a of the unit shaped elements 45 also contains a light component L51 which, because of its incident angle exceeding a critical total reflection angle, totally reflects on the light outgoing surface 45a (see FIG. 5). It has been found through the present inventors' experiments that side lobe, caused by the light L51 which has been totally reflected from the light outgoing surface 45a, can be effectively prevented by designing the unit shaped element 45, whose light outgoing surface angle θa decreases from the end 45b2 toward the top 45b1, such that in a main cross-section of the optical sheet, the light outgoing surface angle θa is not more than 15° in a region containing the top 45b1 and which accounts for at least 15% of the full width of the unit shaped element 45.

As described herein above, according to this embodiment, the occurrence of side lobe can be effectively prevented if the amount of light which is reflected in the unit shaped elements 45 is increased. The effect (prevention of side lobe) has been confirmed by the present inventors' experiments.

According to this embodiment, of light which enters the light outgoing surface 45a of each unit shaped element 45 of the optical sheet 40, especially a side region of the light outgoing surface 45a, at an angle which allows refraction of the light approximately to the front direction, a particular polarization component (e.g. P wave) can be made to outgo in the front direction at a high transmittance and the other polarization component (e.g. S wave) can be made to reflect at a high reflectance. Consequently, while the front direction luminance on the light outgoing surface 40a of the optical sheet 40, which is attributed to the other polarization component (e.g. S wave), decreases, the front direction luminance on the light outgoing surface 40a of the optical sheet 40, which is attributed to the particular polarization component (e.g. P wave), can be significantly enhanced. This effect becomes pronounced by imparting an anisotropic diffusion function, which allows transmitted light to diffuse mainly in the arrangement direction of the unit shaped elements 45 of the optical sheet 40, to the body portion 42 of the optical sheet 40.

In the light source device 20, most of light which has been reflected from the light outgoing surfaces 45a of the unit shaped elements 45 re-enters the optical sheet 40, e.g. after repeating reflections, and can be reused. The polarization state of such light can be changed by reflection. In particular, the other polarization component (e.g. S wave) which has been reflected from the light outgoing surfaces 45a of the unit shaped elements 45 can re-enter the optical sheet 40 as the particular polarization component (e.g. P wave). Accordingly, the front direction luminance on the light outgoing surface 40a of the optical sheet 40, which is attributed to the particular polarization component, can be enhanced more than expected from the data of FIG. 4.

Thus, the optical sheet 40 has a polarization separation function that separates a particular polarization component (e.g. P wave) from the other polarization component (e.g. S wave) and selectively takes out the particular component. The optical sheet 40 is configured such that the polarization separation function can be performed highly effectively on light outgoing in the front direction from the optical sheet 40. The optical sheet 40, when used in combination with the transmissive display unit 15, typically a liquid crystal panel, which solely uses a particular polarization component of natural light, can therefore enhance the efficiency in the use of source light in the display device 10, thereby enhancing the front direction luminance highly effectively.

In the optical sheet 40, the unit shaped element 45 has a tapered cross-sectional shape in a main cross-section. In particular, in a main cross-section, the angle formed by a tangent TL to the outline of the unit shaped element 45 and the normal direction nd of the body portion 42 decreases as the tangent point TP between the tangent TL and the outline moves from the top 42b1 toward the end 45b2. Therefore, even when a portion (region on the end 45b2 side) of the shape of the unit shaped element 45 is designed by focusing on enhancement of the polarization separation function, the excellent light collecting function (light condensing function) of the unit shaped elements 45, due to the shape of the unit shaped element 45, can be maintained as a whole and, in addition, the occurrence of side lobe can be prevented.

Various modifications can be made to the above-described embodiment. Exemplary variations will be described below.

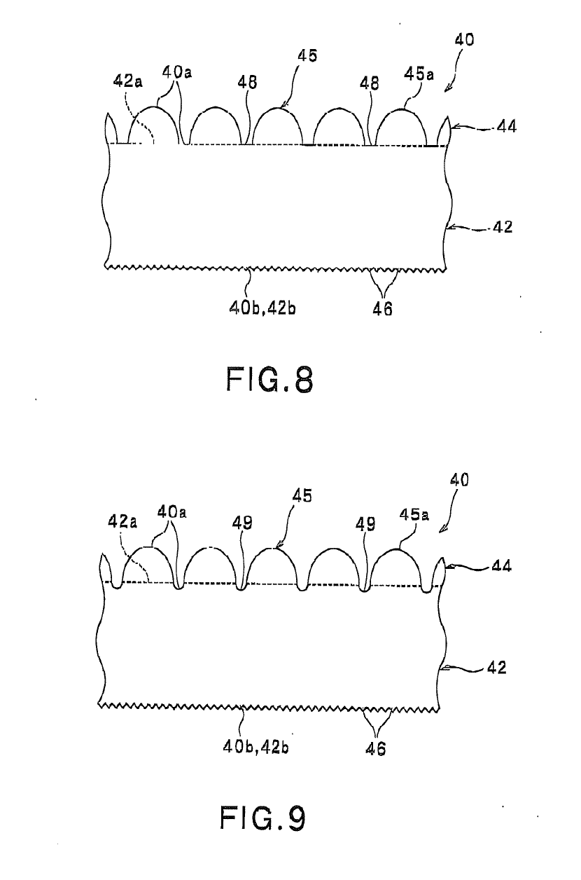

Though in the above-described embodiment adjacent unit shaped elements 45 are disposed in contact with each other, it is possible, for example, to provide a flat portion 48 between two adjacent unit shaped elements 45 as shown in FIG. 8, or to provide a recessed portion 49 between two adjacent unit shaped elements 45 as shown in FIG. 9. In FIGS. 8 and 9 illustrating the variations, the same reference numerals are used for those portions which may be the same as in the above-described embodiment shown in FIGS. 1 through 7.

Though in the above-described embodiment the unit shaped elements 45 of the optical sheet 40 all have the same construction, it is possible, for example, to use an optical sheet 40 containing unit shaped elements of different shapes.

Various modifications can be made to the above-described unit lenses 46, constituting the light incident side surface 42b of the body portion 42 of the optical sheet 40 (the light incident surface 40b of the optical sheet 40), which have been described only by way of example. For example, the unit lens 46 may have a cross-sectional shape corresponding to part of an ellipse or part of a circle. The cross-sectional shape of the unit lens 46 may change along the longitudinal direction of the unit lens 46. Further, the constructions of the large number of unit lenses 46, arranged side-by-side, may differ from one another.

Though in the above-described embodiment the anisotropic light diffusing function is imparted to the body portion 42 of the optical sheet 40 by the unit lenses 46 which constitute the light incident side surface 42b of the body portion 42 of the optical sheet 40 (the light incident surface 40b of the optical sheet 40), it is possible, for example, to form linearly-extending raised and recessed portions, arranged side-by-side, in the light incident side surface 42b of the body portion 42. The body portion 42 will have an anisotropic diffusion function that allows transmitted light to diffuse mainly in the arrangement direction of the unit shaped elements 45 when the longitudinal direction of the raised and recessed portions makes an angle of less than 45° with the longitudinal direction of the unit shaped elements 45 of the optical sheet 40 on the sheet plane of the optical sheet. Such raised and recessed portions can be formed by various known methods. For example, raised and recessed portions can be formed very easily in the light incident side surface 42b of the body portion 42 by carrying out hairline processing of the light incident side surface 42b.

It is not necessary to impart to the body portion 42 of the optical sheet 40 an anisotropic diffusion function that allows transmitted light to diffuse mainly in the arrangement direction of the unit shaped elements 45 of the optical sheet 40. Even if the body portion 45 does not have an anisotropic diffusion function, the unit shaped elements 45 of the optical sheet 40 can sufficiently perform a polarization separation function, as described above. Thus, the body portion 42 may have a flat and smooth surface, constituting the light incident surface 40b of the optical sheet 40, as the light incident side surface 42b opposed to the light outgoing side surface 42a. The term “smooth” herein refers to smoothness in an optical sense. In particular, the term refers to such a degree of smoothness that a certain proportion of visible light is refracted at the light incident surface 40b of the optical sheet 40 (the light incident side surface 42b of the body portion 42) while satisfying the Snell's law. Thus, the light incident side surface 42b of the body portion 42 (the light incident surface 40b of the optical sheet 40) will sufficiently fall into “smooth” surface if the 10-point average roughness Rz (JIS B0601) of the surface 42b is not more than the shortest visible light wavelength (0.38 μm).

Various modifications can be made to the light colleting sheet 30 which has been described only by way of example. For example, though the unit shaped element 35 of the light colleting sheet 30 has a shape corresponding to part of a circle or ellipse in a main cross-section, the unit shaped element 35 may have, for example, a polygonal, such as triangular, cross-sectional shape.

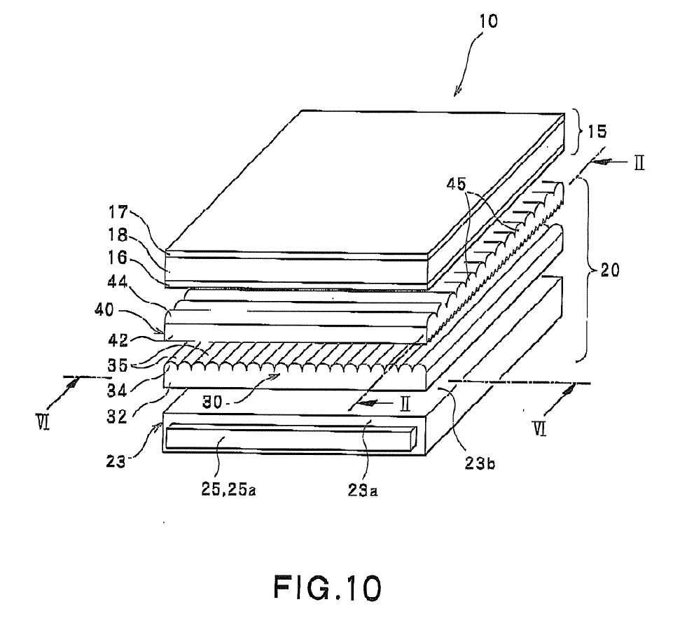

Though in the above-described embodiment each light emitter 25a of the light source 25 of the surface light source device 20 is comprised of a linear cold-cathode tube, it is also possible to use other light emitters, such as point-like LEDs (light emitting diodes), a planar EL (electroluminescence) light emitter, etc. for the light source 25. Though in the above-described embodiment the optical sheet 40 is applied in the direct-type surface light source device 20, the optical sheet may be applied e.g. In an edge light-type (also called side light type) surface light source device. As shown in FIG. 10, the surface light source device 20, when constructed as an edge light-type surface light source device, generally includes a light guide plate (light guide panel) 23, and the light emitting sources 25a (e.g. a light emitter comprised of a large number of LEDs or a cold-cathode tube) of the light source 25 are disposed oppositely on the side surfaces 23a of the light guide plate 23. The optical sheet 40 and the light colleting sheet 30 are disposed on the light guide plate 23 such that the light incident surface of the optical sheet 40 and the light incident surface of the light colleting sheet 30 face the light outgoing surface 23b of the light guide plate 23. Light from the light emitting sources 25a enters the light guide plate 23, and is guide in the light guide plate 23 while outgoing from the light outgoing surface 23b of the light guide plate 23. Also in such an edge light-type surface light source device, the optical sheet 40 can produce similar effects to those produced by the optical sheet 40 when it is applied in the direct-type surface light source device 20.

Further, modifications may be made to the above-described overall construction of the surface light source device 20, incorporating the optical sheet 40, and the transmissive display device 10. For example, an optical sheet(s), etc. having various functions may be additionally incorporated into the surface light source device 20 and the transmissive display device 10.

The above modifications, of course, may be made in an appropriate combination to the above-described embodiment.

What is claimed is:

1. An optical sheet comprising:
a sheet-like body portion; and
unit shaped elements arranged in a arrangement direction on a light outgoing side of the body portion, each of the unit shaped elements extending linearly in a direction intersecting the arrangement direction of the unit shaped elements,
wherein each of the unit shaped element has a tapered cross-sectional shape in a main cross-section which is parallel to both the normal direction of the body portion and the arrangement direction of the unit shaped elements, and
wherein in the main cross-section, an angle of a tangent to either end of an outline of each of the unit shaped elements with respect to a sheet plane of the body portion is not less than 55° and not more than 75°.

2. The optical sheet according to claim 1,
wherein in the main cross-section, an angle of a tangent to the outline of each of the unit shaped elements with respect to the sheet plane of the body portion increases as a tangent point of the tangent on the unit shaped element moves from a top or the outline of the unit shaped element, the farthest point from the body potion, toward either end of the outline of the unit shaped element.

3. The optical sheet according to claim 1,
wherein in the main cross-section, the angle of the tangent to either end of the outline of each of the unit shaped elements with respect to the sheet plane of the body portion is not less than 65° and not more than 75°.

4. The optical sheet according to claim 1,
wherein the body portion has an anisotropic diffusion function that allows transmitted light to diffuse mainly in the arrangement direction of the unit shaped elements.

5. The optical sheet according to claim 4,
wherein a light incident side surface of the body portion is comprised of a large number of unit lenses arranged in a arrangement direction, each of the unit lenses extending linearly in a direction intersecting the arrangement direction of the unit lenses.

6. The optical sheet according to claim 4,
wherein linearly-extending raised and recessed portions are formed in a light incident side surface of the body portion.

7. The optical sheet according to claim 6,
wherein the raised and recessed portions have been formed by hairline processing.

8. The optical sheet according to claim 2,
wherein in the main cross-section, a tangent in contact with the outline of each of the unit shaped elements at a position which is displaced from the end of the unit shaped element by a distance corresponding to 15% of a width of the unit shaped element in a direction parallel to the sheet plane of the body portion, makes an angle of not less than 40° with the sheet plane of the body portion.

9. The optical sheet according to claim 1,
wherein in the main cross-section, a tangent to the outline of each of the unit shaped elements makes an angle of not less than 0° and not more than 15°with the sheet plane of the body portion when a tangent point of the tangent on the outline of the unit shaped element lies in a region that accounts for at least 15% of the full width of each of the unit shaped element in a direction parallel to the sheet plane of the body portion.

10. The optical sheet according to claim 1,
wherein each of the unit shaped elements is configured such that of light which travels toward the end of the unit shaped element in a direction parallel to the main cross-section and part of which is refracted at the light outgoing surface of the unit shaped element and outgoes in the normal direction of the body potion, the other part of the light, which is reflected from the light outgoing surface of the unit shaped element without refraction, either later outgoes from the unit shaped element at an light outgoing angle of not less than 80° or, after outgoing from the unit shaped element, enters an adjacent unit shaped element.

11. The optical sheet according to claim 1,
wherein in the main cross-section, the outline of each of the unit shaped elements is composed of three or more joined arcs, with adjacent two joined arcs having a common tangent at their joint.

12. The optical sheet according to claim 1,
wherein the outline of each of the unit shaped elements in the main cross-section is line-symmetrical with respect to a symmetry axis which is parallel to the normal direction of the body portion.

13. A surface light source device comprising:
a light source; and
the optical sheet according to claim 1 which receives light from the light source.

14. The surface light source device according to claim 13 further comprising a light guide plate,
wherein the light source includes a pair of light sources disposed oppositely on side surfaces of the light guide plate.

15. The surface light source device according to claim 13 further comprising a light colleting sheet,
wherein the light colleting sheet includes: a sheet-like body portion; and unit shaped elements arranged in a arrangement direction on a light outgoing side of the body portion, each of the unit shaped elements extending linearly in a direction intersecting the arrangement direction of the unit shaped elements of the light collecting sheet;
wherein the light source includes linear light emitters;
wherein the arrangement direction of the unit shaped elements of the light colleting sheet intersects the longitudinal direction of the light emitters of the light source and also intersects the arrangement direction of the unit shaped elements of the optical sheet; and
wherein in a main cross-section of the light colleting sheet, which is parallel to both the normal direction of the body portion of the light colleting sheet and the arrangement direction of the unit shaped elements of the light colleting sheet, a width of each of the unit shaped elements of the light colleting sheet, along a direction parallel to the sheet plane of the body portion of the light collecting sheet, is not less than 1.8 times and not more than 2.3 times a height of the unit shaped element of the light colleting sheet along the normal direction of the body portion of the light colleting sheet.

16. A display device comprising:
the surface light source device according to claim 13; and
a transmissive display unit disposed on the light outgoing side of the surface light source device.

17. The display device according to claim 16,
wherein the transmissive display unit includes a lower light polarizing plate and an upper light polarizing plate disposed on the light outgoing side of the lower light polarizing plate, and
wherein a transmission axis of the lower polarizing plate intersects the longitudinal direction of the unit shaped elements of the optical sheet at an angle larger than 45° and smaller than 135° as viewed from the front direction.

18. The display device according to claim 16,
wherein the transmissive display unit includes a lower light polarizing plate and an upper light polarizing plate disposed on the light outgoing side of the lower light polarizing plate, and
wherein the transmission axis of the lower polarizing plate is parallel to the arrangement direction of the unit shaped elements of the optical sheet.
